(19) United States
(12) Patent Application Publication
(10) Pub. No.: US 2025/0296114 A1
(43) Pub. Date: Sep. 25, 2025

(54) ACRYLIC ACID PLASMA POLYMERIZATION FILM AND PRODUCTION METHOD THEREFOR

(71) Applicant: TOYODA GOSEI CO., LTD., Kiyosu-shi (JP)

(72) Inventors: Kazuyuki NAKANISHI, Aichi (JP); Yasuhiro OZAWA, Aichi (JP); Munehisa MATSUI, Aichi (JP); Kazuhiko UMEMOTO, Aichi (JP); Takashi ISEKI, Aichi (JP); Shintaro OKAWA, Aichi (JP); Hiroaki ANDO, Aichi (JP); Akira KAWAGUCHI, Aichi (JP)

(21) Appl. No.: 19/085,453

(22) Filed: Mar. 20, 2025

(30) Foreign Application Priority Data
Mar. 21, 2024 (JP) 2024-045073

(51) Int. Cl. B05D 1/00; C08F 120/06

(52) U.S. Cl. CPC B05D 1/62; C08F 120/06; B05D 2502/00

(57) ABSTRACT

An acrylic acid plasma polymerization film containing C: 35 at % to 45 at %, and O: 7 at % to 12 at %, the balance being H and impurities, and a method for producing the acrylic acid plasma polymerization film, including: joining plasma generated from a first gas and a second gas containing an acrylic acid-based monomer.

### CROSS-REFERENCE TO RELATED APPLICATION

This application is based on and claims priority under 35 USC 119 from Japanese Patent Application No. 2024-045073 filed on Mar. 21, 2024.

### TECHNICAL FIELD

The present invention relates to an acrylic acid plasma polymerization film obtained by polymerizing an acrylic acid-based monomer with plasma.

### BACKGROUND ART

An acrylic resin is transparent and has excellent glossiness, weather resistance, water resistance, chemical resistance, and the like, and is thus used in various products, for examples, a coating film. The acrylic coating film is generally formed by coating an object to be treated with a coating material in which an acrylic acid-based monomer is dispersed and dissolved in a solvent and then heating and drying the coating material. With the heating and drying, the monomer is thermally polymerized into a polymer (resin).

In such a film forming method using a wet process, it is difficult to reduce the CO₂ emission. In addition, since the solvent volatilizes, it is necessary to consider the working environment. Therefore, a film forming method using a dry process using plasma has been proposed, and there are descriptions related to the following patent literatures.
Patent Literature 1: JP2011-245743A
Patent Literature 2: JP2012-135879A

### SUMMARY OF INVENTION

In Patent Literature 1, a mixed gas of argon and acrylic acid is introduced between parallel plate electrodes to form a discharge plasma treatment layer on a polyethylene substrate. In this case, since the acrylic acid itself is converted into plasma and decomposed or the like, the layer formed on the substrate is not necessarily a layer obtained by polymerizing acrylic acid. In addition, in Patent Literature 1, the surface is washed with a solution after the treatment, and the method is not a dry process.

In Patent Literature 2, a silicon-based top coat layer is formed on a polycarbonate resin substrate using plasma CVD. The plasma CVD is performed between parallel electrodes in a vacuum chamber. In the first place, Patent Literature 2 does not describe the polymerization of an acrylic acid-based monomer.

The present invention has been made in view of such circumstances, and an object thereof is to provide a novel acrylic acid plasma polymerization film.

The inventor of the present invention has succeeded in obtaining a novel acrylic acid plasma polymerization film by plasma-treating an acrylic acid-based monomer using a specific method. By developing this achievement, the present invention described below has been completed.

### <<Acrylic Acid Plasma Polymerization Film>>

(1) The present invention relates to an acrylic acid plasma polymerization film containing the following component composition:
C: 35 at % to 45 at %, and O: 7 at % to 12 at %, the balance being H and impurities.

(2) The acrylic acid plasma polymerization film (also simply referred to as a “plasma polymerization film”) according to the present invention has a component composition or a molecular structure different from that of a conventional film (referred to as a “thermal polymerization film”) formed by thermally polymerizing an acrylic acid-based monomer (also simply referred to as a “monomer”).

It is thought that the plasma polymerization film according to the present invention has not only undergoes linear addition polymerization but also undergoes three-dimensional crosslinking, and the monomer is polymerized into a three-dimensional network. Accordingly, it is thought that the plasma polymerization film contains, for example, a ketone, an aldehyde, an ester, and the like which are not originally present in the acrylic acid-based monomer in which a part of carbonyl groups are a raw material.

Such a plasma polymerization film can exhibit more excellent heat resistance, solvent resistance, hardness, transparency, and the like than the conventional thermal polymerization film. In addition, the plasma polymerization film can be formed using a dry process, and can thus contribute to reduction of CO₂ emission and environmental maintenance. Further, the plasma polymerization film according to the present invention can be formed in various environments (for example, under an atmospheric pressure atmosphere), and can thus be used for various objects to be treated.

The reason and the mechanism of obtaining a plasma polymerization film having a composition or structure that cannot be obtained by the conventional thermal polymerization is not clear. At present, it is thought that a high energy electron of plasma appropriately dissociates and activates the acrylic acid-based monomer to promote addition polymerization and crosslinking, and polyacrylic acid in which the monomer is polymerized to increase the molecular weight is deposited and formed on a surface of a workpiece to form the plasma polymerization film according to the present invention.

### <<Production Method/Treated Object>>

The present invention is also understood as a method for producing an acrylic acid plasma polymerization film. For example, the present invention relates to a method for producing the above acrylic acid plasma polymerization film, including: joining plasma generated from a first gas and a second gas containing an acrylic acid-based monomer.

The present invention is also understood as a treated product obtained by forming an acrylic acid plasma polymerization film on a surface of an object to be treated (base or substrate). The plasma polymerization film is not limited to a top coat (upper layer), and may be an under coat (lower layer) or the like. In addition, the plasma polymerization film may be a single layer or multiple layers, and may be a mixture of a plurality of types of monomers having different components or structures.

### <<Others>>

(1) The term “plasma polymerization” includes not only linear addition polymerization of an acrylic acid-based monomer but also a crosslinking reaction between side chains. The polymerization reaction may proceed on a surface to be treated which is covered.

(2) In the present description, upper and lower sides (upstream and downstream) are along a flow direction of plasma or a raw material gas (acrylic acid-based monomer), and are not related to the top and bottom unless otherwise specified. For example, a surface on the upstream side is referred to as an upper surface, and a surface on the downstream side is referred to as a lower surface.

(3) For a wave number, “near X cm⁻¹” is, for example, within a range of about X±50 cm⁻¹, X±35 cm⁻¹, or X±25 cm⁻¹.

Being near the atmospheric pressure is, for example, a gas pressure (P) satisfying 0.01P₀≤P≤1.1P₀ with respect to the atmospheric pressure (P₀), and the type of the gas is not limited. The “quasi-atmospheric pressure” is a gas pressure lower than the atmospheric pressure, for example, 0.01P₀≤P≤P₀. Based on the standard atmospheric pressure (P₀=1.01325×10⁵ Pa≈1×10⁵ Pa), for example, 1×10³ Pa≤P≤1×10⁵ Pa may be thought to be near the atmospheric pressure.

(4) In the present description, “x to y” includes a lower limit value x and an upper limit value y, unless otherwise specified. Any numerical value included in various numerical values or numerical value ranges described in the present description may be newly provided as a new lower limit value or upper limit value such as “a to b”. In the present description, “x to y nm” means x nm to y nm, unless otherwise specified. The same applies to the other unit systems.

### BRIEF DESCRIPTION OF DRAWINGS

FIG. 1A is a schematic view illustrating a plasma polymerization apparatus.

FIG. 1B is a cross-sectional view of a main portion thereof.

FIG. 2A shows an infrared absorption spectrum of each sample.

FIG. 2B is a partially enlarged view thereof.

FIG. 3 is a Raman spectrum of each sample.

### DESCRIPTION OF EMBODIMENTS

One or more constituent elements optionally selected from the present description may be added to the above constituent elements in the present invention. The contents described in the present description apply to both objects (a film, a coated object, a treated object, an apparatus, and the like) and methods (a production method, a film forming method, a treatment method, and the like) as appropriate. Even constituent elements related to a method may be constituent elements related to an object. Which embodiment is best depends on the subject, the performance required, and the like.

### <<Acrylic Acid-based Monomer>>

A plasma polymerization film is formed by bringing an acrylic acid-based monomer (also simply referred to as a “monomer”) into contact with plasma. Examples of such a monomer include acrylic acid (C₃H₄O₂), an acrylic acid ester, and a methacrylic acid ester. The acrylic acid ester is, for example, methyl acrylate (C₄H₆O₂) or ethyl acrylate (C₅H₈O₂). The methacrylic acid ester is, for example, methyl methacrylate (C₅H₈O₂).

### <<Film Composition>>

The plasma polymerization film has, for example, the following component composition. Unless otherwise specified, the component (concentration) in the present description is an atomic ratio (simply denoted by “%”) with respect to the entire film (100 at %). C is, for example, 35% to 45%, 36% to 44%, or 36.5% to 43%. O is, for example, 7% to 12%, 8% to 11%, or 9% to 10.5%. Although depending on components of a plasma source gas (first gas) and a raw material gas (second gas), the balance is, for example, H and (inevitable) impurities. As an example, the content of C in both a monomer and a polymer of ethyl acrylate is 33.3% and 13.3% (theoretical value).

The component composition of such a plasma polymerization film is identified by, for example, Rutherford backscattering spectrometry (RBS), hydrogen forward scattering spectrometry (HFS), nuclear reaction analysis (NRA), or the like, depending on the element to be identified.

### <<Film Structure>>

The plasma polymerization film has a functional group (a C—H group, a C═O group, a C—O group, a C═C group, or the like) corresponding to the raw material (acrylic acid-based monomer), and is specified (identified) by the following spectrometry.

### (1) Infrared Absorption Spectrometry (IR)

According to an IR spectrum, the plasma polymerization film has, for example, a C—H group having a peak near 1400 cm⁻¹, a C—O group having a peak near 1150 cm⁻¹, and a C═O group having a peak near 1700 cm⁻¹.

In addition, a ratio of a peak intensity of the C═O group to a peak intensity of the C—H group (C═O group/C—H group) is, for example, 0.7 to 1.8, 0.8 to 1.6, or 1.1 to 1.4. A ratio of a peak intensity of the C—O group to the peak intensity of the C—H group (C—O group/C—H group) is, for example, 0.2 to 3.5, 0.7 to 1.5, or 1 to 1.3.

Focusing on the C—O group in the plasma polymerization film, for example, a wave number at a peak top is 1720 cm⁻¹ to 1733 cm⁻¹, or 1724 cm⁻¹ to 1730 cm⁻¹, and a half width is 26 cm⁻¹ to 47 cm⁻¹, or 28 cm⁻¹ to 38 cm⁻¹.

### (2) Raman Spectroscopy

According to an Raman spectrum, the plasma polymerization film has, for example, a C—H group having a peak near 3000 cm⁻¹, a C═O group having a peak near 1700 cm⁻¹, and a C═C group having a peak near 1600 cm⁻¹

A ratio of a peak intensity of the C═C group to a peak intensity of the C—H group (C═C group/C—H group) is, for example, 0.03 to 0.25, 0.05 to 0.18, or 0.06 to 0.16. A ratio of the peak intensity of the C═C group to the peak intensity of the C—O group (C═C group/C═O group) is, for example, 0.1 to 1.7, 0.2 to 1.4, or 0.4 to 1.

In addition, a half width of the C═O group is, for example, 28 cm⁻¹ to 35 cm⁻¹ or 29 cm⁻¹ to 33 cm⁻¹, and a half width of the C═C group is, for example, 30 cm⁻¹ to 100 cm⁻¹ or 45 cm⁻¹ to 80 cm⁻¹.

### (3) Functional Group

The plasma polymerization film may include one or more of an aldehyde (group), a ketone (group) or an ester (group). These are made of at least a part of carbonyl groups contained in the monomer. Such a plasma polymerization film may have a three-dimensional structure in which crosslinking has progressed.

### <<Properties>>

A thickness of the plasma polymerization film is not limited, and is, for example, 20 nm to 1000 nm, 50 nm to 700 nm, or 100 nm to 400 nm.

For example, the plasma polymerization film has a transmittance in a visible light region (wavelength: 400 nm to 800 nm) of, for example, 85% to 100%, 88% to 98%, or 90% to 95%.

### <<Film Formation>>

The plasma polymerization film is obtained, for example, by joining (mixing) plasma generated from a first gas and a second gas containing an acrylic acid-based monomer.

### (1) First Gas (Plasma Source Gas)

The first gas is, for example, mainly composed of an inert gas (a rare gas (Ar, Ne, He, or the like), N₂, or the like). In order to promote polymerization or crosslinking, hydrogen may be contained. A flow rate ratio (hydrogen/inert gas) is, for example, 0.3 to 3 or 0.5 to 2.

### (2) Second Gas (Raw Material Gas)

The second gas may contain a raw material acrylic acid-based monomer in the form of a gas (vapor) or atomized particles. The second gas may contain a solvent (such as water) for the acrylic acid-based monomer. The second gas is preferably supplied in a manner appropriate for a form for supplying the plasma (for example, elongated line or layer).

### (3) Treatment Atmosphere

The treatment atmosphere may be a vacuum atmosphere or a (quasi) atmospheric pressure atmosphere (for example, 1000 Pa to 50000 Pa). When the treatment is performed in a treatment furnace (chamber), gas leakage and the like can be avoided. For example, when a surface to be treated in an atmosphere of atmospheric pressure or quasi-atmospheric pressure is irradiated with plasma and the second gas is supplied to the plasma, a polymerization film is obtained on the surface to be treated. Polymerization, chemical vapor deposition, and the like of the plasma-activated monomer may occur on the surface to be treated.

### (4) Apparatus

The plasma polymerization film is formed (produced) by using, for example, a plasma polymerization apparatus including a plasma head for supplying the plasma and a raw material gas head for supplying the second gas.

The plasma head, for example, includes a first electrode, an intermediate insulator, and a second electrode stacked from the upstream side where the first gas is supplied, and has a communication hole penetrating the first electrode, the intermediate insulator, and the second electrode to allow the first gas to flow. When a voltage is applied between the first electrode and the second electrode, plasma generated between the electrodes is ejected from a lower end opening side of the communication hole.

The raw material gas head joins or mixes the second gas to the downstream side of the plasma. An ejection port of the plasma head and an ejection port of the raw material gas head are, for example, in the form of an elongated and thin slit. When such a plasma head and raw material gas head are moved (are used for scanning) relative to an object to be treated, a uniform plasma polymerization film can be efficiently formed on a surface of the object to be treated.

A power source that generates an electric field between the first electrode and the second electrode may be a DC power source, an AC power source, or a pulse power source. The applied voltage (peak-to-peak value/maximum and minimum voltage difference) is, for example, 200 V to 3000 V, or further 400 V to 1500 V. A frequency of the AC power source or the pulse power source is, for example, 0.1 kHz to 20 kHz or 1 kHz to 10 KHz.

### EXAMPLES

A plasma polymerization film was fabricated and the characteristics were evaluated. The present invention will be described in more detail with reference to such specific examples.

### <<Apparatus>>

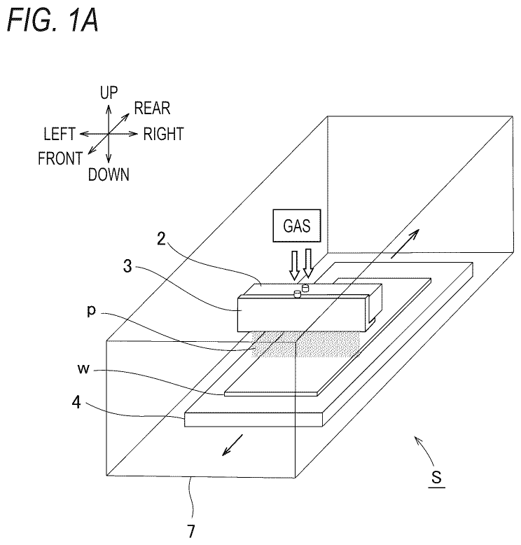

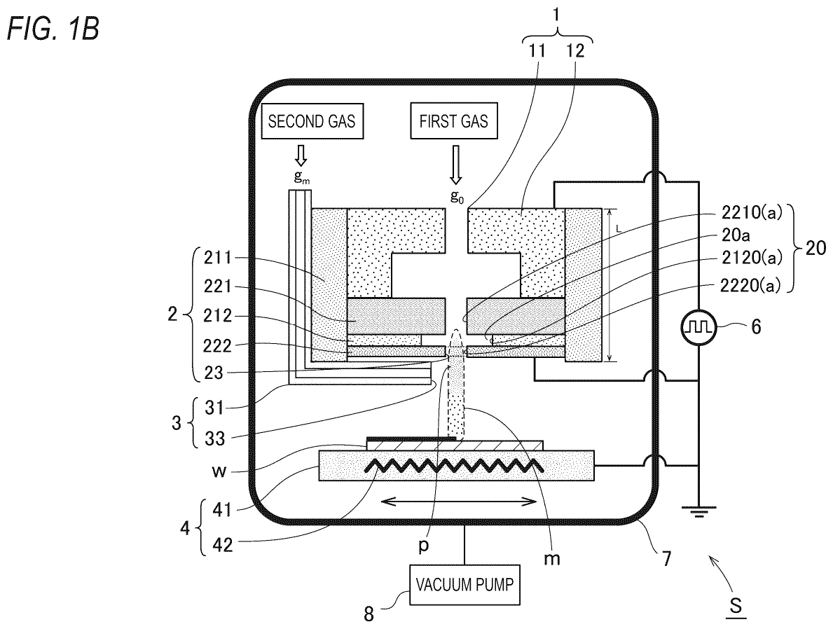

A plasma polymerization apparatus S (simply referred to as an “apparatus S”) used for film formation is generally shown in FIG. 1A, and a cross section of a main portion thereof is shown in FIG. 1B. Both figures are collectively referred to as “FIG. 1”. For convenience of description, directions of arrows shown in FIG. 1A are referred to as a front-rear direction, a left-right direction, and an up-down direction, as appropriate. The up-down direction follows a flow of the first gas or the plasma in the apparatus S, and the upstream side is an upper side and the downstream side is a lower side.

The apparatus S includes an introduction unit 1, a plasma head 2, a raw material gas head 3, a stage 4 on which a workpiece w (object to be treated) is placed, a power source 6, a chamber 7, and a vacuum pump 8. The introduction unit 1, the plasma head 2, the raw material gas head 3, and the stage 4 are accommodated (stored) in the chamber 7.

(1) The introduction unit 1 includes an introduction port 11 that takes in a first gas g₀, which is a plasma source, and a cover 12 having a substantially rectangular parallelepiped shape.

The first gas g₀ taken into the cover 12 through the introduction port 11 is introduced into a communication hole 20. The cover 12 is made of a metal (for example, stainless steel) and is conductively connected to an electrode plate 221 to be described later.

(2) The plasma head 2 includes the electrode plate 221 (first electrode), an insulating plate 212 (intermediate insulator), and an electrode plate 222 (second electrode) stacked in order from above, and an insulating tube 211 (exterior insulator) surrounding outer peripheral sides thereof. An inner peripheral surface of the insulating tube 211 is in close contact with outer peripheral (ends) surfaces of the electrode plate 221, the insulating plate 212, the electrode plate 222, and the introduction unit 1 (cover 12). The insulating plate 212, the electrode plate 221, and the electrode plate 222 each have a rectangular shape, and the insulating tube 211 has a rectangular tubular shape.

The plasma head 2 further has the slit-like communication hole 20 penetrating substantially at a center in the up-down direction and extending in the left-right direction. The communication hole 20 is formed by a hole 2210 of the electrode plate 221, a hole 2120 of the insulating plate 212, and a hole 2220 of the electrode plate 222.

When a high voltage is applied between the electrode plate 221 and the electrode plate 222, discharge (mainly glow discharge) occurs between an inner wall surface 2210a of the hole 2210 and an inner wall surface 2220a of the hole 2220, and plasma p is generated in the communication hole 20. The plasma p is extruded into the first gas g₀ flowing from the upstream side to the downstream side in the communication hole 20, and is ejected from an elongated plasma ejection hole 23 formed of a lower end side opening of the communication hole 20.

The inner wall surface 2210a of the hole 2210 and the inner wall surface 2220a of the hole 2220 are flush with each other over the entire periphery in the up-down direction. An inner wall surface 2120a of the hole 2120 is displaced outward (in the front-rear direction) with respect to each of the inner wall surfaces, and forms a recessed portion 20a.

(3) The raw material gas head 3 includes a nozzle 31 for a raw material gas gₘ disposed close to the plasma head 2. A tip opening of the nozzle 31 is an elongated and thin slit-like raw material gas ejection hole 33. The raw material gas gₘ is a monomer gas to be polymerized by reacting with the plasma p.

The raw material gas ejection hole 33 is disposed near the downstream side of the plasma ejection hole 23. The plasma ejection hole 23 and the raw material gas ejection hole 33 extend parallel to a longitudinal direction (the left-right direction in FIG. 1A) and have substantially the same shape. The raw material gas ejection hole 33 is slightly separated from a surface of the workpiece w and is disposed close to the plasma ejection hole 23. The raw material gas ejection hole 33 is slightly inclined toward the workpiece w such that the raw material gas gₘ flows along the flow of the plasma p.

(4) The inside of the chamber 7 is evacuated by the vacuum pump 8 to be brought into a quasi-atmospheric pressure atmosphere. The stage 4 includes a base 41, a heater 42 built in the base 41, a drive mechanism (not shown) that moves the base 41 in a plane direction (X-axis direction and/or Y-axis direction), and a control device (not shown) that controls the heater 42 and the drive mechanism. A temperature of the workpiece w placed on the base 41 is controlled by the heater 42 and the control device. Position management and a treatment speed of the workpiece w placed on the base 41 are adjusted by the drive mechanism and the control device.

The power source 6 includes a DC pulse power source device that generates a pulsed voltage at a desired frequency. With the power source 6, a voltage necessary for plasma generation is applied between the electrode plate 221 and the electrode plate 222. The electrode plate 222 and the stage 4 (base 41) are both grounded, and the electrode plate 221 is energized via the cover 12.

For the plasma head 2, reference is made to the descriptions in JP2021-82491A and JP2022-127786A. The contents described in these patent literatures are also incorporated in the present description by reference.

### <<Film Formation>>

Using the apparatus S, a plasma polymerization film of ethyl acrylate (monomer) was formed on a substrate (stainless steel or polycarbonate) as the workpiece w. The stainless steel substrate was used for spectroscopic analysis, and the polycarbonate substrate was used for transmittance measurement. The details are as follows.

### (1) Specification of Apparatus

A rolled plate of stainless steel (SUS304) was used for the electrode plates 221 and 222, and a fired body of alumina (Al₂O₃) was used for the insulating tube 211 and the insulating plate 212. The electrode plate 221 had a thickness of 5 mm, the electrode plate 222 had a thickness of 1 mm, and the insulating plate 212 had a thickness (t) of 1 mm. The insulating tube 211 had a thickness of 5 mm and a height (L) of 33 mm. The opening shapes of the plasma ejection hole 23 and the raw material gas ejection hole 33 were 1 mm×100 mm. A vertical distance from the surface of the workpiece w to the plasma ejection hole 23 was 6 mm. An angle between outflow directions of the raw material gas ejection hole 33 and the plasma ejection hole 23 was 90°.

### (2) Film Formation Conditions

Using the apparatus S, plasma polymerization films as samples 1 to 8 were formed under the conditions shown in Table 1. At this time, the inside of the chamber 7 was evacuated by the vacuum pump 8 to be 1333 Pa (absolute pressure).

As the second gas, vapor of ethyl acrylate was used. The vapor was generated by reducing the pressure inside a container containing ethyl acrylate from the atmospheric pressure (gauge pressure: −0.09 MPa), and the volatilized ethyl acrylate vapor was supplied to the chamber through a mass flow meter.

A pulse voltage (rectangular wave) was applied between the electrode plate 221 and the electrode plate 222. The voltage (Peak to Peak value) and the frequency are also shown in Table 1.

The substrate was irradiated with the monomer-containing plasma starting at room temperature of 25° C. and increasing toward an end temperature. The temperature of the substrate when taken out from the chamber 7 (end temperature) is also shown in Table 1.

### (3) Comparative Example (Sample C1)

As a comparative example, toluene was added to ethyl acrylate, followed by heating to 90° C., and 1 mass % of azobisisobutyronitrile (AIBN) as a polymerization initiator was further added, which was then applied onto a substrate and dried. In this way, a thermal polymerization film was prepared on the substrate.

### <<Measurement>>

### (1) Component

The components of the polymerization film in each sample were measured by using RBS, HFS, and NRA. For the measurement, a tandem type electrostatic accelerator Pelletron 5SDH-2 (manufactured by National Electrostatics Corporation) was used. Specific measurement conditions are as follows.

In NRA measurement and RBS/HFS measurement at the same time,
incident ion: 4He++, 4He++, incident energy: 3710 keV, 2300 keV
incident angle: 0 deg, 75 deg, scattering angle: 160 deg, 160 deg, recoil angle: −30 deg
sample current: 4 nA, 3 nA, beam diameter: 1 mmo, 1 mmo, in-plane rotation: none, none, irradiation amount: 56 μC (note that samples 1 to 3:0.2μC, sample 4:3.8 μC)

In order to reduce damage to the sample, measurement was taken at multiple points with different positions, and the integrated data was used for the evaluation. The results are also shown in Table 1.

### (2) Structure

The IR spectrum and the Raman spectrum of each polymerization film were measured. The details are as follows.

The IR spectrum was measured using a Fourier transform infrared spectrophotometer (FTIR: FT-IR NICOLET iS50+infrared microscope CONTINU μM, manufactured by Thermo Fisher Scientific). Specifically, the chemical structure of the film on a metal substrate (made of stainless steel) was subjected to infrared analysis using a microscopic reflection method. The analysis conditions were: 100 μm square, Au mirror blank, MCT detector, number of integrations: 64, measurement resolution: 4 cm⁻¹, and n=3 (number of measurements).

Peak areas of main functional groups in the spectrum were calculated, and area ratios of the peaks were determined as follows. In addition, the half width of the carbonyl group peak near 1725 cm⁻¹ and the peak top wave number were determined. The reading wave numbers of a base line (B) and an area (A) are as follows.

### [Peak Area]

Alkyl group (—C—H: near 2900 cm⁻¹): both (B) and (A) are 3040 cm⁻¹ to 2800 cm⁻¹
Carbonyl group (—C—O: near 1725 cm⁻¹): both (B) and (A) are 1800 cm⁻¹ to 1600 cm⁻¹
Ether group (—C—O: near 1200 cm⁻¹): both (B) and (A) are 1355 cm⁻¹ to 980 cm⁻¹

### [Half Width of Main Peak of Carbonyl Group]

A base line was drawn from 1815 cm⁻¹ to 1600 cm⁻¹, and a peak width at half an absorbance height of a vertical line drawn from the peak top to the base line was defined as the half width.

The Raman spectrum was measured using a Raman spectrophotometer (NRS-7500 manufactured by JASCO Corporation). Specifically, Raman analysis was performed directly on each polymerization film. Considering variability, the samples were analyzed at two or three randomly selected different points under conditions most suitable for the samples. An example of the analysis conditions is as follows.
Excitation wavelength: 532 nm, exposure time: 5 seconds, number of integrations: 60, CDD: DU970P_BVF,
grating: L400, slit width: φ25 μm, aperture: 44000 μm,
objective lens: 100×, laser intensity: 0.7 mW

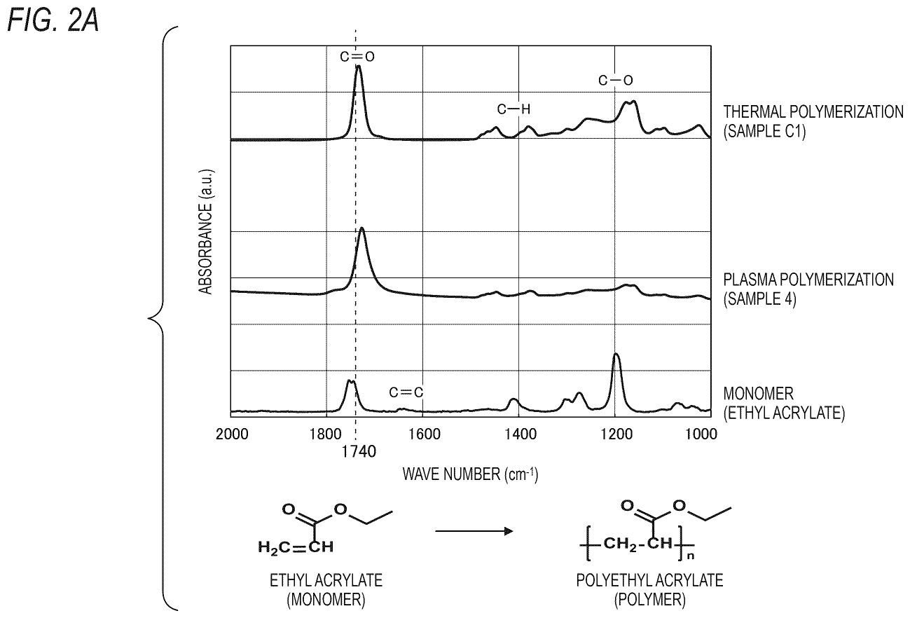

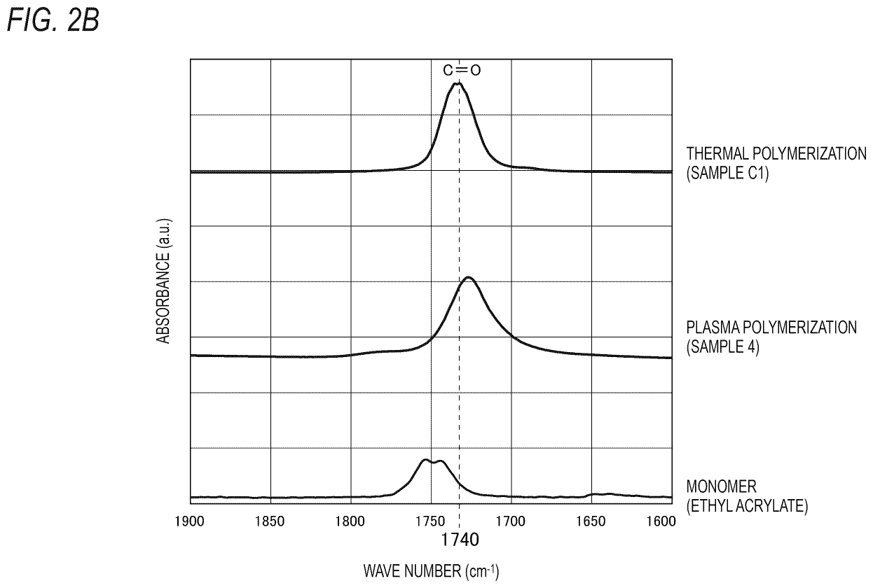

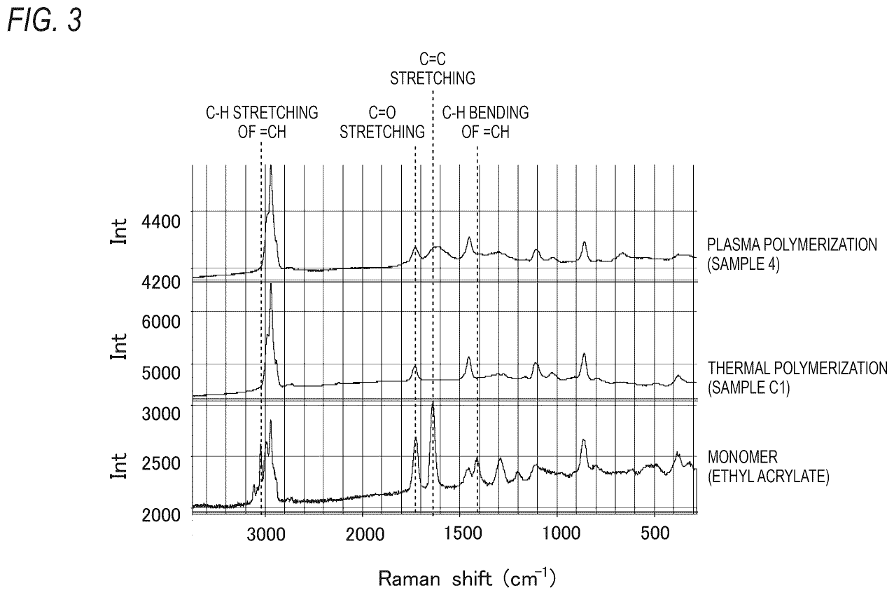

FIG. 2A shows an overall view of the IR spectrum, FIG. 2B shows an enlarged view of a main portion thereof, and FIG. 3 shows the Raman spectrum. Based on each spectrum, the peak intensity ratio (PI), the half width (HW), and the peak top wave number (PT) were determined. The results are summarized in Table 1.

### (3) Transmittance

The transmittance of each polymerization film to visible light (wavelength: 400 nm to 800 nm) was measured using an ultraviolet-visible-near infrared spectrophotometer (SolidSpec-3700, manufactured by Shimadzu Corporation). The transmittance of each film was 85% to 90%.

### (4) Thickness

The thickness of each sample was measured by the step method using a Surfcorder (ET4000A manufactured by Kosaka Laboratory Ltd.). The thickness of each film was 30 nm to 500 nm.

### <<Evaluation>>

### (1) Component Composition

As can be seen from Table 1, the thermal polymerization film as the sample C1 contains C: 33% and O: 13%, which are the same as those of the raw material monomer. However, the plasma polymerization film contains more C and less O than those of the raw material monomer. It is thought that in the plasma polymerization film, crosslinking is promoted three-dimensionally between linear polymers that have been addition-polymerized.

### (2) Structure

As can be seen from FIGS. 2A and 2B or Table 1, in the IR spectrum, the peak position (wave number) representing the C—O group is shifted to a lower wave number side and the half width is larger in the plasma polymerization film than in the thermal polymerization film.

In addition, the peak intensity ratio (C—O group/C—H group) of the C—O group (near 1150 cm⁻¹) to the C—H group (near 1400 cm⁻¹) is significantly smaller in the plasma polymerization film than in the thermal polymerization film.

As can be seen from FIG. 3 or Table 1, in the Raman spectrum, the half width of the peak representing the C═C group (near 1600 cm⁻¹) is far larger in the plasma polymerization film than in the thermal polymerization film.

In addition, the peak intensity ratio (C═C group/C═O group) of the C═C group (near 1600 cm⁻¹) to the C═O group (near 1700 cm⁻¹) is significantly larger in the plasma polymerization film than in the thermal polymerization film.

It is clear from these analysis results that the plasma polymerization film according to the present invention is greatly different from the conventional thermal polymerization film in terms of component composition and structure. This is thought to be because the plasma polymerization film according to the present invention has polymerization and crosslinking promoted three-dimensionally more than the thermal polymerization film, and contains a larger amount of ketones, aldehydes, and the like.

TABLE 1

| | Film formation conditions | | | | | | Analysis results | | | | | | | | | |
|---|---|---|---|---|---|---|---|---|---|---|---|---|---|---|---|---|
| | | | | | | | Rutherford | | | | | | | | | |
| | | | | | | Sub- | backscattering | | Infrared spectroscopy | | | | Raman spectroscopy | | | |
| | | | Second | | | strate | spectrometry | | Peak | | | | Peak | | | |
| | | | gas | Power source | | End | Component | | intensity | | Peak | Half | intensity | | Half | |
| Sam- | First gas | | Ethyl | Fre- | Volt- | temper- | composition (at | | ratio | | top | width | ratio | | width | |
| ple | Ar | H₂ | acrylate | quency | age | ature | %/balance: H) | | C═O/ | C—O/ | (cm⁻¹) | (cm⁻¹) | C═C/ | C═C/ | (cm⁻¹) | |
| No. | (sccm) | (sccm) | (sccm) | (kHz) | (V) | (° C.) | C | O | C—H | C—H | C═O | C═O | C—H | C═O | C═O | C═C |
| 1 | 200 | 100 | 70 | 2 | 600 | 42 | 38 | 10 | 0.96 | 0.78 | 1731 | 27.2 | 0.04 | 0.22 | 29.7 | 35.9 |
| 2 | 200 | 100 | 70 | 2 | 900 | 62 | 38 | 10 | 0.78 | 0.51 | 1729 | 29.1 | 0.07 | 0.47 | 31.5 | 60.7 |
| 3 | 200 | 100 | 70 | 2 | 1200 | 80 | 37 | 10 | 1.27 | 1.22 | 1725 | 44.6 | 0.08 | 0.57 | 32.7 | 68.1 |
| 4 | 200 | 100 | 70 | 5 | 600 | 59 | 40 | 10 | 1.70 | 1.14 | 1725 | 37.5 | 0.06 | 0.38 | 31.9 | 53.3 |
| 5 | 200 | 100 | 70 | 5 | 900 | 98 | 42 | 9 | 1.50 | 1.15 | 1726 | 36.9 | 0.14 | 0.80 | 32.2 | 79.6 |
| 6 | 200 | 100 | 70 | 5 | 1200 | 160 | — | — | — | — | 1732 | 34.5 | 0.22 | 1.53 | 31.7 | 87.5 |
| 7 | 0 | 300 | 70 | 2 | 900 | 74 | 41 | 8 | 0.44 | 0.23 | 1728 | 36.0 | 0.20 | 1.39 | 31.9 | 72.7 |
| 8 | 300 | 0 | 70 | 2 | 900 | 45 | 43 | 8 | 1.04 | 0.77 | 1728 | 27.0 | 0.04 | 0.25 | 30.6 | 46.6 |

| | | | | | | | | | | | |
|---|---|---|---|---|---|---|---|---|---|---|---|
| C1 | (Thermal polymerization) | 33 | 13 | 1.88 | 3.72 | 1734 | 24.3 | 0.01 | 0.04 | 26.6 | 17.1 |

What is claimed is:

1. An acrylic acid plasma polymerization film comprising the following component composition:
C: 35 at % to 45 at %, and
O: 7 at % to 12 at %,
the balance being H and impurities.

2. The acrylic acid plasma polymerization film according to claim 1, which has a C—O group at near 1150 cm⁻¹, a C—H group at near 1400 cm⁻¹, and a C—O group at near 1700 cm⁻¹ as determined from peak positions in an infrared absorption spectrum.

3. The acrylic acid plasma polymerization film according to claim 2, which satisfies the following peak intensity ratio:
C═O group/C—H group: 0.7 to 1.8
C—O group/C—H group: 0.2 to 3.5.

4. The acrylic acid plasma polymerization film according to claim 2, wherein the C—O group satisfies the following:
wave number at peak top: 1720 to 1733 cm⁻¹
half width: 26 to 47 cm⁻¹.

5. The acrylic acid plasma polymerization film according to claim 3, wherein the C—O group satisfies the following:
wave number at peak top: 1720 to 1733 cm⁻¹
half width: 26 to 47 cm⁻¹.

6. The acrylic acid plasma polymerization film according to claim 1, which has a C—H group at near 3000 cm⁻¹, a C═O group at near 1700 cm⁻¹, and a C═C group at near 1600 cm 1 as determined from peak positions in a Raman spectrum.

7. The acrylic acid plasma polymerization film according to claim 6, which satisfies the following peak intensity ratio:
C═C group/C—H group: 0.03 to 0.25
C═C group/C—O group: 0.1 to 1.7.

8. The acrylic acid plasma polymerization film according to claim 6, which satisfies the following half width:
C═O group: 28 to 35 cm⁻¹
C═C group: 30 to 100 cm⁻¹.

9. The acrylic acid plasma polymerization film according to claim 7, which satisfies the following half width:
C—O group: 28 to 35 cm⁻¹
C═C group: 30 to 100 cm⁻¹.

10. The acrylic acid plasma polymerization film according to claim 1, which has a thickness of 20 nm to 1000 nm.

11. The acrylic acid plasma polymerization film according to claim 1, which has a transmittance of light at a wavelength of 400 nm to 800 nm of 85% or more.

12. The acrylic acid plasma polymerization film according to claim 10, which has a transmittance of light at a wavelength of 400 nm to 800 nm of 85% or more.

13. The acrylic acid plasma polymerization film according to claim 1, comprising at least one of: an aldehyde; a ketone; or an ester.

14. A method for producing the acrylic acid plasma polymerization film according to claim 1, comprising: joining plasma generated from a first gas and a second gas containing an acrylic acid-based monomer.

15. The method according to claim 14, wherein the film is formed on a surface to be treated under an atmospheric pressure or quasi-atmospheric pressure atmosphere.

16. The method according to claim 14, wherein the first gas includes an inert gas containing hydrogen.

17. The method according to claim 14, wherein the acrylic acid-based monomer is at least one of: an acrylic acid; or an acrylic acid ester.

18. The method according to claim 14, wherein
the method is carried out by using a plasma polymerization apparatus including a raw material gas head for supplying the second gas and a plasma head for supplying the plasma,
the raw material gas head mixes the second gas to a downstream side of the plasma, and
the plasma head includes a first electrode, an intermediate insulator, and a second electrode stacked from an upstream side where the first gas is supplied, and a communication hole penetrating the first electrode, the intermediate insulator, and the second electrode to allow the first gas to flow, and applies a voltage between the first electrode and the second electrode to generate plasma, which is ejected from a lower end opening side of the communication hole.
